(19) United States
(12) Patent Application Publication
(10) Pub. No.: US 2006/0161525 A1
(43) Pub. Date: Jul. 20, 2006

(54) Method and system for supporting structured aggregation operations on semi-structured data

(75) Inventors: Rajesh R. Bordawakar, Yorktown Heights, NY (US); Christian A. Lang, New York, NY (US)

Correspondence Address: FERENCE & ASSOCIATES, 409 BROAD STREET, PITTSBURGH, PA, 15143, US

(73) Assignee: IBM Corporation, Armonk, NY (US)

(21) Appl. No.: 11/037,640

(22) Filed: Jan. 18, 2005

(51) Int. Cl. G06F 17/30

(52) U.S. Cl. 707/3

(57) ABSTRACT

The introduction of extensions to query processing systems for XML documents that allow the analysis of such documents via grouping and aggregation operations. Assumed is the existence of an analysis module for extracting information on how parts of an XML document interrelate with other parts. This information is then used together with a user query in order (1) to partition the nodes of the document in various ways and (2) to compute and output the aggregation value of each such partition. To these ends, there are provided new query operators and extensions to query processing systems comprising a hierarchical node list generator and a hierarchical node list processor. The former takes the grouping information from the query as input and generates document node partitionings. The latter takes the node partitionings as input and computes aggregation values for each partition and generates a query result that is returned to the user.

### FIELD OF THE INVENTION

The present invention generally relates to analyzing XML documents and, more particularly, to supporting aggregation operations that exploit structural properties of the XML documents.

### BACKGROUND OF THE INVENTION

Throughout the instant disclosure, numerals in brackets—[]— are keyed to the list of numbered references towards the end of the disclosure.

Over the years, structured aggregation operations for Online Analytical Processing (OLAP) have been studied extensively. Traditional OLAP systems view data using a logical multi-dimensional representation. Vassiliadis and Sellis present a survey of logical models for OLAP computations [6]. Gray et al. first introduced the OLAP CUBE operator [4]. Most database vendors support OLAP in their database systems and most of the OLAP operators, such as, GROUP BY, ROLLUP, DRILLDOWN, and CUBE are supported in the SQL standard as well [2, 6].

Recently, value-based grouping has been investigated for Xquery [1,3]. This proposal, however, can not express structural grouping operations.

A need has been recognized in connection with improving upon the shortcomings and disadvantages presented by conventional efforts.

### SUMMARY OF THE INVENTION

In accordance with at least one presently preferred embodiment of the present invention, there is broadly contemplated the introduction of extensions to query processing systems for XML documents that allow the analysis of such documents via grouping and aggregation operations. There is assumed the existence of an analysis module for extracting information on how parts of an XML document interrelate with other parts (e.g., document node hierarchies). This information is then used together with a user query (that is extended to include aggregation operators) in order (1) to partition the nodes of the document in various ways and (2) to compute and output the aggregation value of each such partition. To these ends, there are provided new query operators and extensions to query processing systems comprising a hierarchical node list generator and a hierarchical node list processor. The former takes the grouping information from the query as input and generates document node partitionings. The latter takes the node partitionings as input and computes aggregation values for each partition and generates a query result that is returned to the user.

For the partitioning of the nodes, two types of operators are broadly contemplated herein: grouping by multiple independent parts of the document (in order to analyze various scenarios and viewpoints) and grouping by dependent parts of the document (in order to analyze a document at different “zoom levels”). It is to be appreciated that all extensions are compatible with (but orthogonal to) existing query processing systems and algorithms.

In summary, one aspect of the invention provides a system for performing structured aggregation of XML documents, the system comprising: an arrangement for reading scoped dimension information for an input XML document; an arrangement for accessing tree information of an input XML document; an arrangement for parsing a user query; an arrangement for executing the user query; and an arrangement for returning a query result as a hierarchical structure.

Another aspect of the invention provides a method of performing structured aggregation of XML documents, the method comprising the steps of: reading scoped dimension information for an input XML document; accessing tree information of an input XML document; parsing a user query; executing the user query; and returning a query result as a hierarchical structure.

Furthermore, an additional aspect of the invention provides a program storage device readable by machine, tangibly embodying a program of instructions executed by the machine to perform method steps for performing structured aggregation of XML documents, the method comprising the steps of: reading scoped dimension information for an input XML document; accessing tree information of an input XML document; parsing a user query; executing the user query; and returning a query result as a hierarchical structure.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 is a schematic representation of a system into which embodiments of the present invention can be integrated.

FIG. 2 is a schematic representation of a system in accordance with an embodiment of the present invention.

FIG. 3 is a schematic representation of a sample input document.

FIG. 4 is a schematic representation of a sample input scoped dimension descriptor.

FIG. 5 is a flow chart illustrating an embodiment of a method to perform GROUP BY node partitioning.

FIG. 6 is a flow chart illustrating an embodiment of a method to perform GROUP BY EXPAND node partitioning.

FIG. 7 is a flow chart illustrating an embodiment of a method to perform GROUP BY COLLAPSE node partitioning.

FIG. 8 is a flow chart illustrating an embodiment of a method to perform GROUP BY TREE node partitioning.

FIG. 9 is a flow chart illustrating an embodiment of a method to compute the aggregation value of node partitions and to assemble the query result.

### DESCRIPTION OF THE PREFERRED EMBODIMENTS

Some background information of interest may be found in the copending and commonly assigned U.S. Patent Application entitled “Methods and Systems for Analyzing XML Documents”, which is filed concurrently with the instant application and which is hereby fully incorporated by reference as if set forth in its entirety herein.

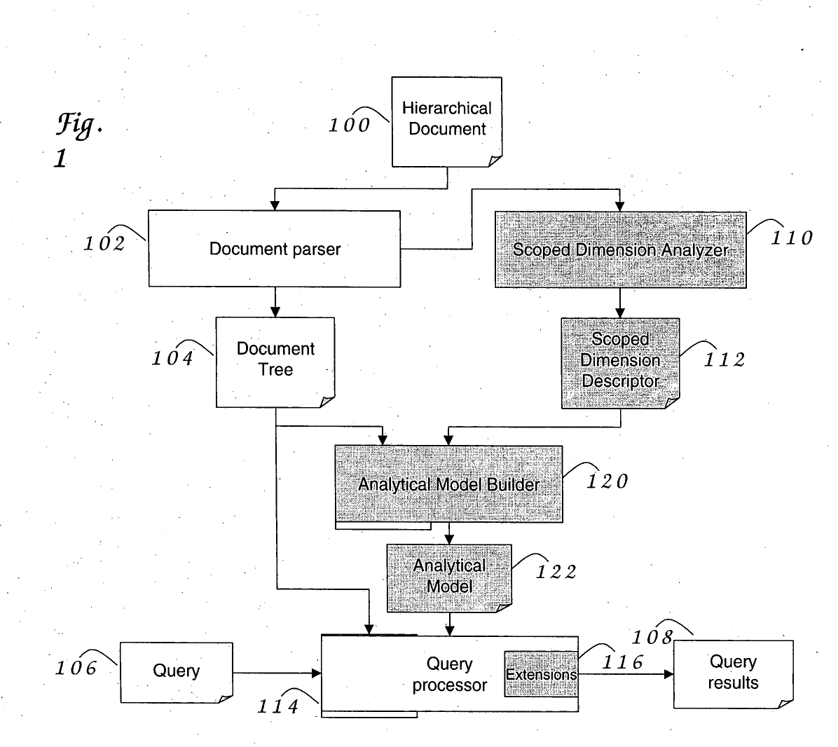

A general architecture in which the embodiments of the present invention may preferably be embedded, can be seen in FIG. 1. The shaded boxes indicate new or modified components. At a high level, a hierarchical document (100) is parsed by the parser module (102) and analyzed by the scoped dimension analyzer module (110), resulting in a tree representation of the document (104) and a scoped dimension descriptor data structure (112). These two structures are then read by the analytical model builder (120) in order to generate an analytical model (122) for the document. This analytical model and the document tree (104) are then read by the query processor (114) together with the user-provided query (106) and a query result (108) is generated and returned to the user.

At least one presently preferred embodiment of the present invention relates to inner workings of the query processor (114) with respect to aggregation queries. It assumes the document parser (102) is provided by some other means, for example by an XML document parser. It also assumes that the scoped dimension analyzer (110) and the analytical model builder (120) are provided by some other means. It also assumes that the part of the query processor (114) that handles non-aggregation queries is provided by some other means, for example an XQuery processor for XML documents. Further discussion of these various components is not included herein as these components are peripheral to the present discussion.

In the following detailed description, it is assumed that the hierarchical document is an XML document and that the user queries are XQuery statements. This, however, is only for the purpose of illustration and does not limit the embodiments of the present invention solely to such types of documents or queries.

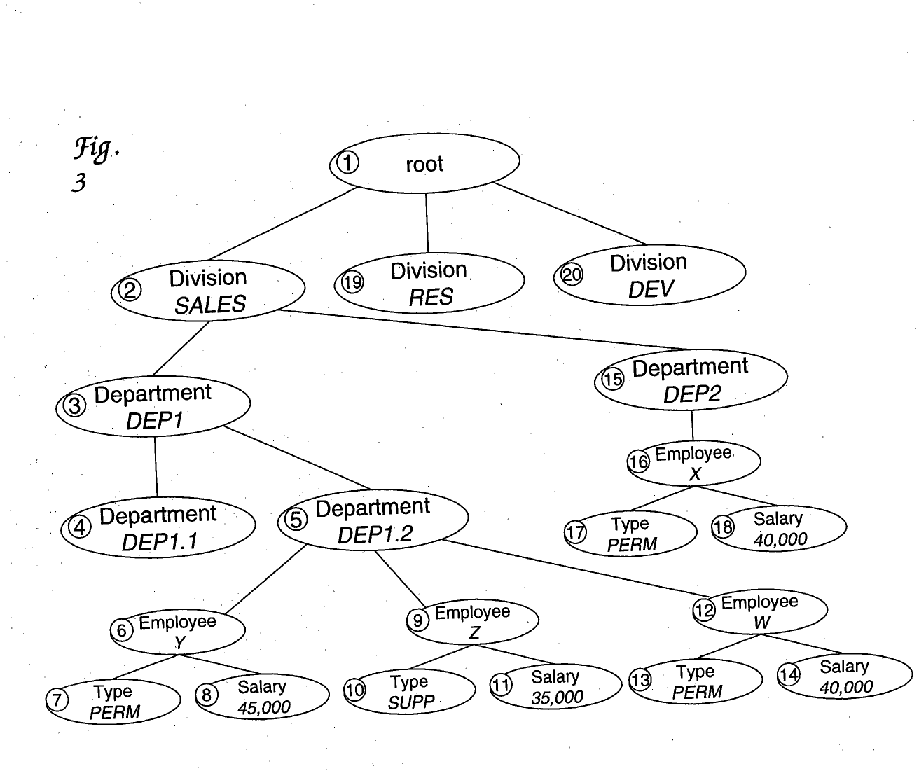

Each input XML document is assumed to be represented internally by a graph structure which includes nodes that represent the tags and edges that represent the nesting of tags. As an example for illustrative purposes herein, it can be assumed the input document is describing employee information, including a reporting structure, as shown in FIG. 3.

The scoped dimension descriptor structure (112 in FIG. 1) preferably stores information regarding which paths in the XML document are regarded as independent dimensions, dependent dimensions, and how the dimensions are interrelated. This information is needed by the analytical model builder (120) to construct an analytical model of the document. This analytical model is a dimension descriptor structure augmented with the data obtained from the original document tree (104). The analytical model is needed by the query processor (114) for correct query result assembly (108).

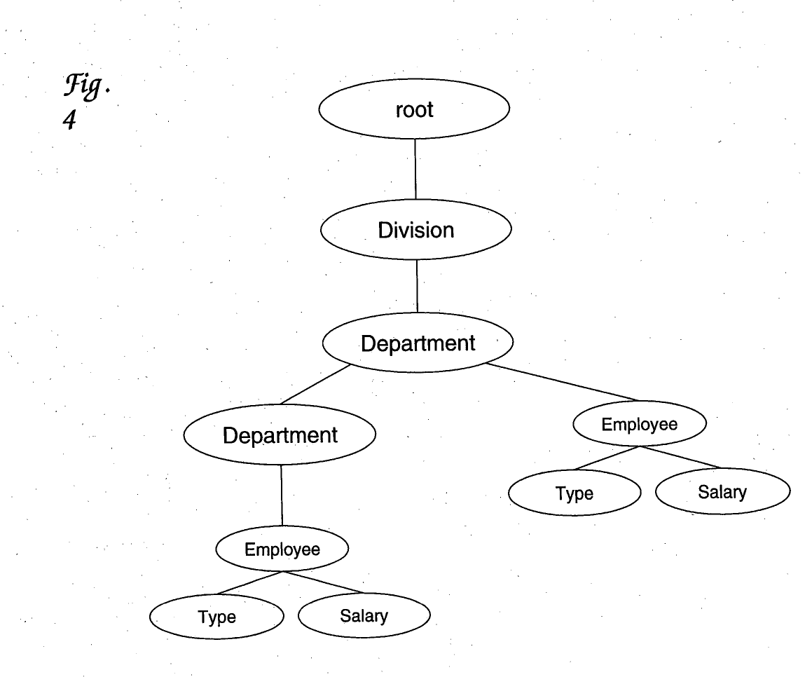

It is assumed, for the present discussion, that the scoped dimension descriptor (112) can be logically represented by a graph structure as shown in FIG. 4. The given example shows a logical view of the scoped dimension descriptor for the example in FIG. 3. Paths from any node M to any other node N represent a “scoped dimension” in the scope of M. Scoped dimensions that are sub-paths of each other are called “dependent dimensions” under their scope, while all other dimensions are called “independent dimensions” under their scope. For example,

“/Division/Department/Department” and

“/Division/Department/Employee” are independent dimensions while

“/Division” and “/Division/Department” are dependent dimensions.

The analytical model in the present example could be represented by pointers pointing from each node of the dimension descriptor structure to one or more nodes in the original document tree. For example, node “Division” in FIG. 4 could point to the three “Division” nodes in FIG. 3, thereby tying the values “SALES”, “RES”, and “DEV” in the dimension descriptor structure. However, other representations are possible.

It is assumed, for the present discussion, that a query over XML documents includes a part that describes which nodes of the document to select and a part that describes what to do with those selected nodes in order to generate a query result. In XQuery, for example, the FOR, WHERE, and ORDER BY keywords are used to select nodes and an order on them, while the RETURN keyword is used to describe how to use those nodes to generate a result. Referring to the example in FIG. 3 again, the XQuery statement

FOR $e IN //EMPLOYEE

WHERE $e/SALARY>40,000

ORDER BY $e/SALARY

RETURN<result> <name> $e/name </name> <salary> $e/salary </salary> </result>

selects EMPLOYEE nodes whose salary is greater than 40,000 and sorts them by salary. In the RETURN statement it then assembles result tuples consisting of the employee name and salary.

In the context of the embodiments of the present invention, it may be assumed that XQuery is extended by aggregation operators that affect both the selection part and the processing part. For selection, it may be assumed that additional operators are available that allow the grouping of nodes. In case of XQuery, the extended query expression may appear as follows (keeping in mind, of course, that any precise syntax employed need not be limited to the syntax used in this example):

FOR $e IN //EMPLOYEE

WHERE $e/SALARY>40,000

GROUP BY $e/GENDER AS $g

RETURN
<result>
FOR $m IN MEMBERS($g)
   RETURN <group> <gender> $m/GENDER </gender> <avgSalary> AVG($M/SALARY) </avgSalary> </group>
   </result>

This query would first group all employees by gender (line 3) and then assemble the result group-wise in the loop in line 6. The result could be, for example,
<result> <group> <gender> female </gender> <avgsalary> 33,276 </avgSalary> </group> <group> <gender> male </gender> <avgsalary> 35,284 </avgSalary> </group> </result>

It is to be appreciated that the grouping (in this example, by gender) is an independent step from the computation of the aggregation function (in this example, AVG). This means that different types of groupings can be combined with different types of aggregation functions. In accordance with at least one preferred embodiment of the present invention, four different types of grouping operators are defined. All grouping operators require the analytical model (122) for proper grouping. The aggregation functions are not limited by the embodiments of the present invention. Any aggregation function that was used in the original query language can be used in the extended version as discussed herein.

When no specific result format is required, the above query can be simplified to:

FOR $e IN //EMPLOYEE

WHERE $e/SALARY>40,000

GROUP BY $e/GENDER AS $g

RETURN

<result> AVG($g/SALARY) AS avgSalary </result>

Here, $g/SALARY will be expanded implicitly into a loop as shown above (without the gender component in the result set).

As another example, the GROUP BY clause in the above example may be replaced by

GROUP BY ($e/GENDER, $e USING height($e) AS level)

In this case, the employees will be grouped first by gender and then within a gender group, by the height in the document tree (i.e., in this case the level in the organizational hierarchy). It is to be appreciated that the use of $e in both grouping expressions ensures that the same node is referred to. It is also to be appreciated that value-based (e.g., gender) and structure-based (e.g., height) attributes can be mixed arbitrarily in the grouping expression.

The examples just above used independent dimensions to perform the grouping and aggregation. As another example, aggregation can be performed using the dependent dimensions of XML documents. The expression

GROUP BY COLLAPSE ($r//SALARY, $r//DIVISION)

will group employee salaries first by lowest level SALARY nodes' values, then by the next higher level nodes' values, and so on, until the DIVISION nodes. In other words, when computing the average value again, first the individual salaries would be returned, then the average salaries on the lowest department levels, then the next higher department levels, and so on, until the average salaries per division.

Overall, four operators for grouping are broadly contemplated in accordance with at least one embodiment of the present invention. Each operator is listed in more detail in the following together with an example using FIG. 3.

1. GROUP BY(p1 USING f1 AS $t1, . . . , pn USING fn AS $tn) AS $g

The regular GROUP BY operator takes n independent dimensions as arguments and generates a list of document node lists by subsequently replacing each grouping expression “pi USING fi AS $ti” by a list of nodes (in document order) addressed by pi and with the same value under function fi. If no function is given, the value of pi itself is used. The “AS” expressions are used for naming the expressions preceding them.

### EXAMPLE

GROUP BY($r//Type, $r//Salary)→(((13, 14),(17, 18)),((7, 8)),((10, 11)))

The numbers in the result list indicate the node ids from FIG. 3. In this example, the first group includes the two pairs (13,14) and (17,18) since they both have the same values for Type (PERM) and Salary (40,000).

2. GROUP BY EXPAND((p1, p2) USING f1 AS $t1) AS $g

The expanding GROUP BY operator takes two dependent dimensions p1 and p2 which indicate the start and end of the expansion (p2 must be in the scope of p1). It generates a list of node lists by subsequently grouping nodes selected by p2 based on the values of the current expansion of p1 towards p2 as computed by f1 (e.g., if p1=“$r//A” and p2=“$r//A/B/C”, then expansions of p1 towards p2 are $r//A, $r//A/B, and $r//A/B/C). The other syntactic components are as described before.

### EXAMPLE

GROUP BY EXPAND(($r//Division, $r//Salary))→((8, 11, 14, 18))(8, 11, 14), (18)),(8, 11, 14), (18)), ((8), (11), (14), (18)))

3. GROUP BY COLLAPSE((p1, p2) USING f1 AS $t1) AS $g

The collapsing GROUP BY operator takes two dependent dimensions p1 and p2 which indicate the start and end of the reduction (p1 must be in the scope of p2). It generates a list of node lists similar to the expanding GROUP BY but starting at the lowest level and “expanding backwards” towards the higher levels.

### EXAMPLE

GROUP BY COLLAPSE(($r//Salary, $r//Division))→((8), (11), (14), (18)),(8, 11, 14), (18)),(8, 11, 14), (18)) ((8, 11, 14, 18)))

4. GROUP BY TREE(p1 USING f1 AS $t1, . . . , pn USING fn AS $tn) AS $g

The tree-based GROUP BY operator is similar to the basic GROUP BY operator but in addition to replacing each grouping expression with nodes based on some function value, it also replaces each grouping expression with NULL which essentially means “any value”. The grouping expressions (a,b,c) will therefore be replaced by (NULL, NULL, NULL), (a1, NULL, NULL), (a2, NULL, NULL), . . . , (NULL, b1, NULL), . . . , (a1, b1, NULL), . . . , (a1, bj, ck).

### EXAMPLE

GROUP BY TREE($r//Type, $r//Salary)→(((7,8), (10,11), (13,14), (17,18)), ((7,8), (13,14), (17,18)), ((10,11)), ((7,8)), ((10,11)), ((13,14),(17,18)), ((13,14),(17,18)), ((7,8)), ((10,11)))

Any user query with or without aggregation extensions may be transformed into a query tree that is an abstract representation of the query. The extensions proposed in accordance with at least one embodiment of the present invention can be realized as one more operand branch (e.g., for GROUP BY) in the node selection component of the query tree. This way, any existing query optimization techniques can be reused without change for the new extended aggregation operators.

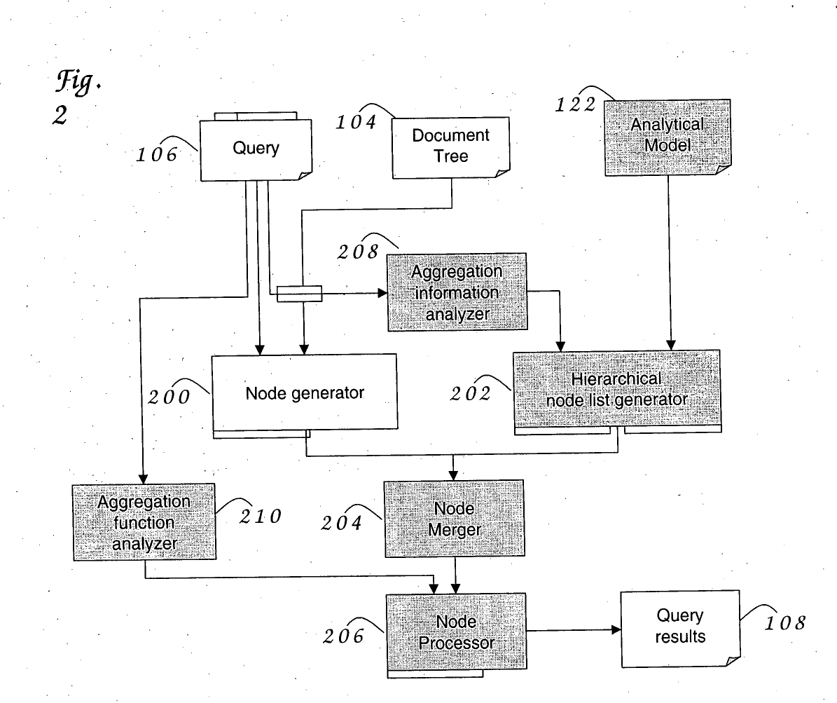

In accordance with a preferred embodiment of the present invention, a query processor (114) and extensions (116) are laid out in greater detail in FIG. 2. As shown, given user query (106) together with the XML document tree (104) is used by the node generator (200) to generate a list of nodes selected from the document by the query. This part of the processing can be undertaken essentially by any suitable arrangement, e.g., it can be replaced by any standard XQuery processor. The user query (106) is also used together with the analytical model (122) to generate a hierarchical node list. For that purpose, the query (106) is examined by an aggregation information analyzer module (208) to determine which grouping operator is used and which nodes participate in the grouping and how the partitioning is defined (based on which value). This information together with the analytical model (122) is then used by the hierarchical node list generator (202) to generate multiple partitionings of the document nodes. It is to be appreciated that the resulting hierarchical node list is a list by itself but each element of the list may again be a list, and so on, until the last list which is a list of nodes.

Both the normal node list generated by the node generator (200) and the hierarchical node list generated by the hierarchical node list generator (202) are then merged into one list by a node merger (204). The merging can be accomplished by simple concatenation of the lists or through a more complex operation. It is important, however, that the result is a hierarchical node list.

Finally, a node processor (206) preferably takes the merged node list and aggregation information from the query and generates the query result (108). The aggregation information from the query is extracted by the aggregation function analyzer (210) and includes information on the aggregation operation to use (e.g., AVG, MAX, MIN, SUM) and naming information to generate a correctly formatted result.

The disclosure now turns to a detailed discussion of preferred embodiments of the hierarchical node list generator (202) and the node processor (206).

The hierarchical node list generator (202) receives aggregation information from the aggregation information analyzer (208) and an analytical model (122) derived from the XML document. It then determines which of the four supported grouping operators is present (if any) in the aggregation information. If none is found, the resulting hierarchical node list is empty. Otherwise, one of the following methods (based on the grouping operator) is executed to generate a hierarchical node list.

GROUP BY Operation

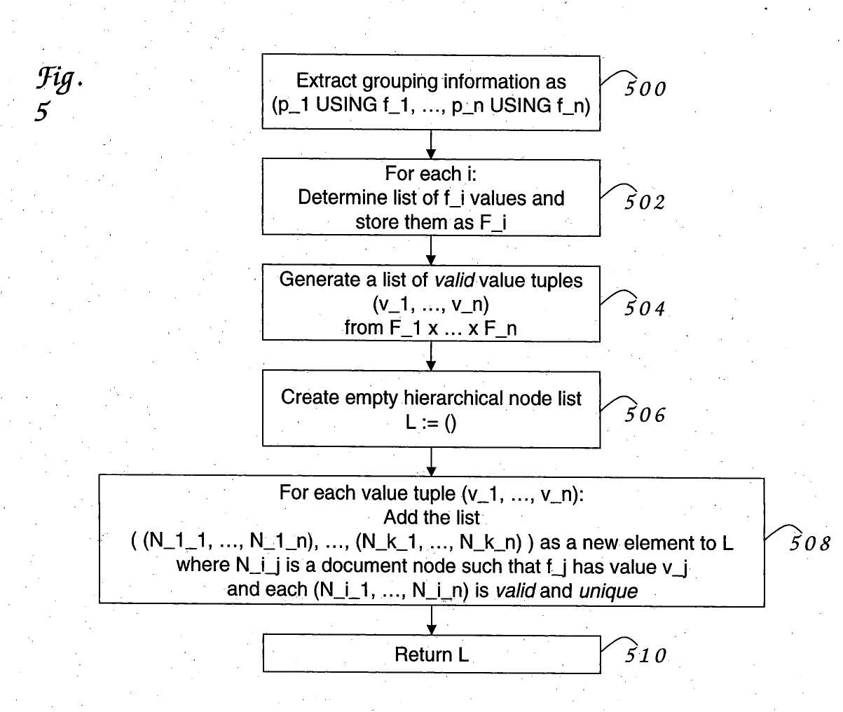

Referring to FIG. 5, one embodiment of a method for performing a GROUP BY operation is illustrated. As illustrated, the grouping information is extracted from the aggregation information (500). The only relevant parts are the path information pᵢ and the function used for grouping, fᵢ. For each pᵢ/fᵢ pair, the list of fᵢ values that can be reached for the given document is determined and stored as Fᵢ (502). This information can be obtained from the analytical model (122). Next, out of the cross product of all sets Fᵢ, a subset is determined based on structural and/or value restrictions given in the aggregation information (e.g., second value has to be larger than first value). This set is then sorted and stored in a list of valid value tuples (504). Next, the result list L is initialized (506) and then populated (508). For the population, the list of valid value tuples is iterated over. For each tuple found, a list of valid node tuples is created and added to L as a new element. Similar to the validity of value tuples, the validity of a node tuple is determined by structural and/or value restrictions given in the aggregation information (e.g., second node has to be sibling of first node). This way, the list L becomes a list of lists of n-tuples. The resulting list L is then returned (510).

GROUP BY EXPAND Operation

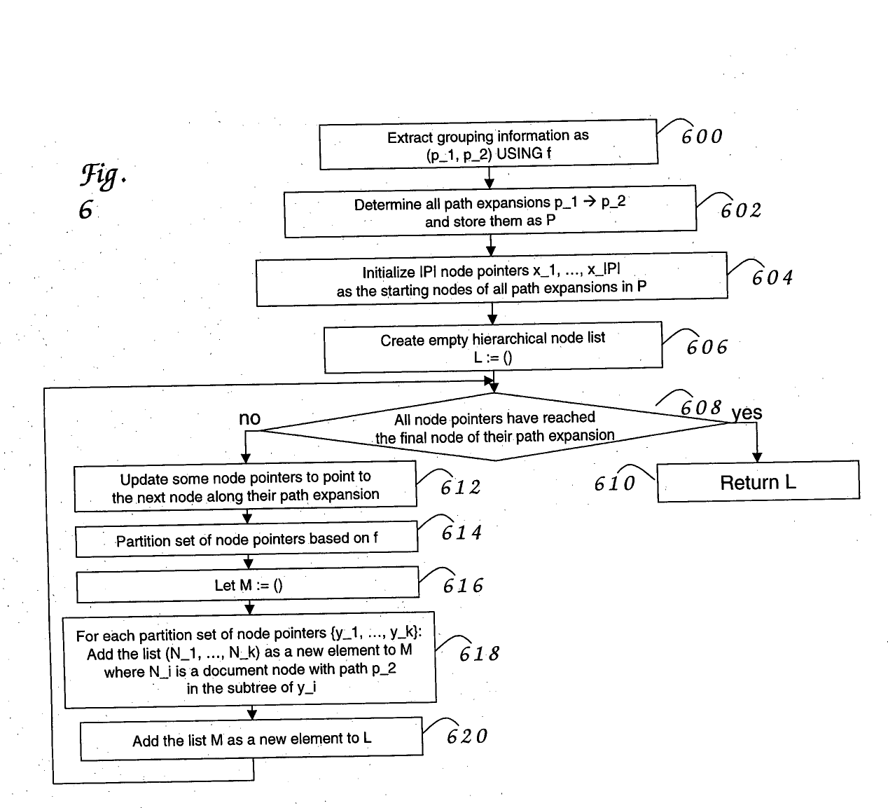

Referring to FIG. 6, one embodiment of a method for performing a GROUP BY EXPAND operation is illustrated. As illustrated, the grouping information is extracted from the aggregation information (600). The only relevant parts are the start and end of the expansion (p₁ and p₂, respectively) and the grouping function f. Next, all possible path expansions starting from p₁ ending with p₂ are computed for the given document and stored as P (602). This information can be obtained from the analytical model (122). Afterwards, |P| node pointers are initialized to the starting points of all path expansions (604). These pointers mark the current expansion level in the document. Then, the resulting hierarchical node list is initialized (606) and populated. If all node pointers have reached the last node in their corresponding path expansion (608), L is returned (610). If the check (608) fails, more node pointers can be updated. In this case, some (this can be one, all, or a subset of) node pointers are moved to their child nodes along the expansion path (612). Next, the set of node pointers is partitioned based on the function f (614).

This means that f is applied to the nodes of all current node pointers and the resulting value determines which node pointers will be grouped together in one partition set. Once this partitioning is done, a new list of node lists M is initialized (616), populated (618), and added to L as a new element (620). The population encompasses, for each partition set, adding a list of document nodes N₁, . . . , Nₖ to M such that each Nᵢ is a node with path p₂ and located in the subtree of one of the partition set nodes. Once M was added to L, it is again checked whether some node pointers can be further updated or whether all pointers have reached their final node (608). For this operation, L is a list of lists of node lists.

GROUP BY COLLAPSE Operation

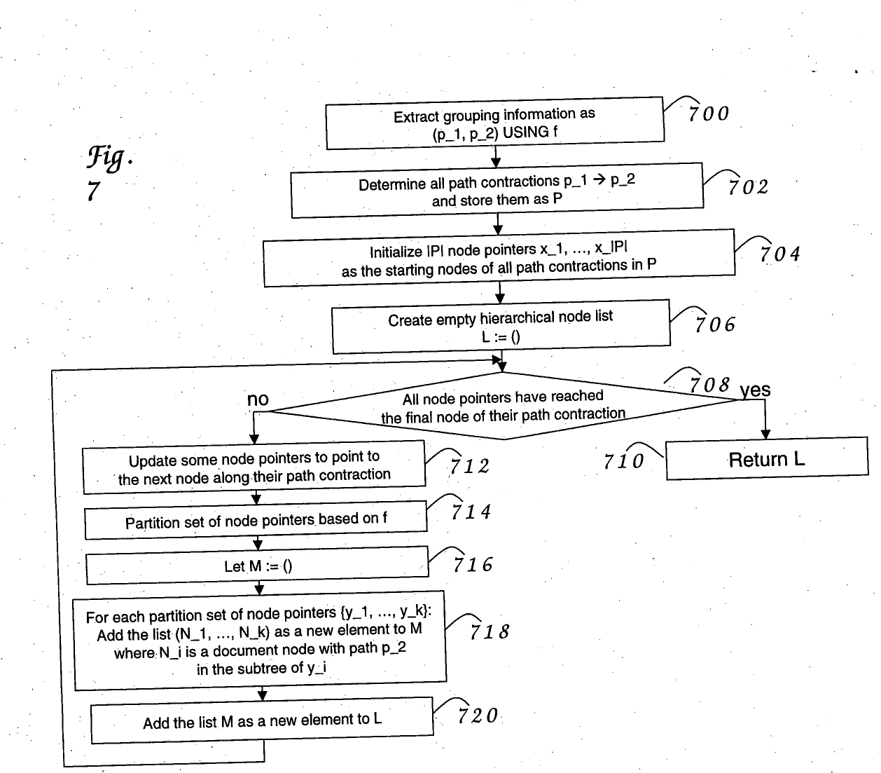

The GROUP BY COLLAPSE operation is similar to the GROUP BY EXPAND operation but instead of considering path expansions, it considers path contractions. Referring to FIG. 7, one embodiment of a method for performing a GROUP BY COLLAPSE operation is illustrated. As illustrated, the grouping information is extracted from the aggregation information (700). The only relevant parts are the start and end of the contraction (p₁ and p₂, respectively) and the grouping function f. Next, all possible path contractions starting from p₁ ending with p₂ are computed for the given document and stored as P (702). This information can be obtained from the analytical model (122). Afterwards, |P| node pointers are initialized to the starting points of all path contractions (704). These pointers mark the current contraction level in the document. Then, the resulting hierarchical node list is initialized (706) and populated. If all node pointers have reached the last node in their corresponding path contraction (708), L is returned (710). If the check (708) fails, more node pointers can be updated. In this case, some (this can be one, all, or a subset of) node pointers are moved to their parent nodes along the contraction path (712). Next, the set of node pointers is partitioned based on the function f (714). This means that f is applied to the nodes of all current node pointers and the resulting value determines which node pointers will be grouped together in one partition set. Once this partitioning is done, a new list of node lists M is initialized (716), populated (718), and added to L as a new element (720). The population encompasses, for each partition set, adding a list of document nodes N₁, . . . , Nₖ to M such that each Nᵢ is a node with path p₁ and located in the subtree of one of the partition set nodes. Once M was added to L, it is again checked whether some node pointers can be further updated or whether all pointers have reached their final node (708). For this operation, L is a list of lists of node lists.

GROUP BY TREE Operation

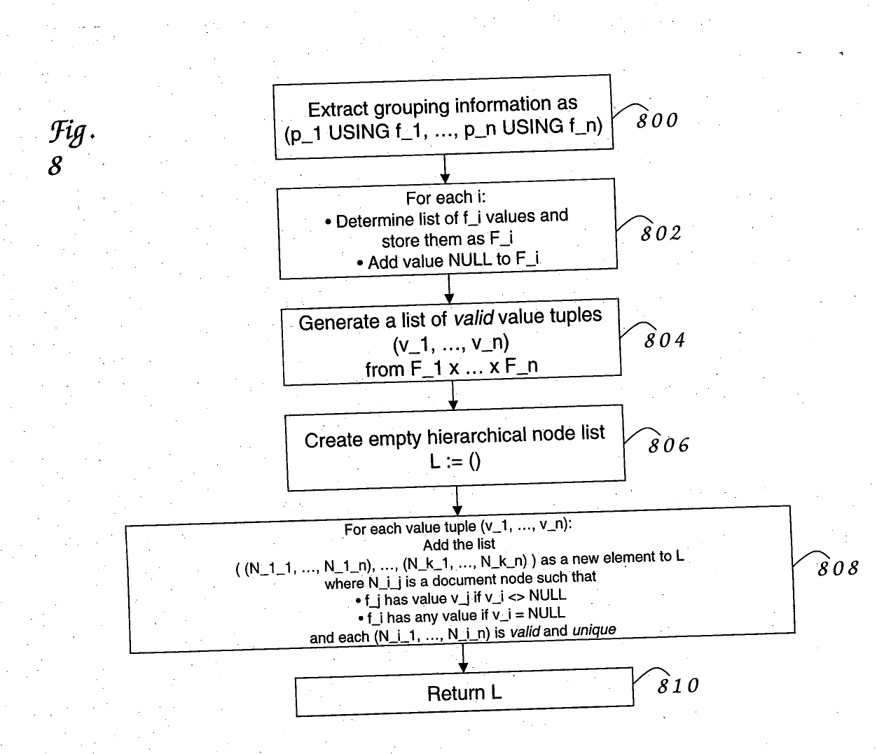

The GROUP BY TREE operation is similar to the GROUP BY operation but each component of the grouping can also assume the special value NULL. Referring to FIG. 8, one embodiment of a method performing the GROUP BY TREE operation is illustrated. First, grouping information is extracted (800). Next, all possible values for each grouping function are determined and stored (802). In contrast to GROUP BY, this method adds the special value NULL to each list Fᵢ. Next, the valid value tuples are determined (804). If any constraint has to be checked with one of the constraint components being NULL, the constraint is assumed to be valid. Once the valid value tuples are determined, the result list L is initialized (806) and populated (808). For the population, the list of valid value tuples is iterated over. For each tuple found, a list of valid node tuples is created and added to L as a new element. A node tuple is valid if all structural and/or value restrictions given in the aggregation information are complied with. The special value NULL in a value tuple is treated like a “joker”, i.e. any node value complies with it. Similar to GROUP BY, the list L becomes a list of lists of n-tuples. Next, the populated list L is returned (810).

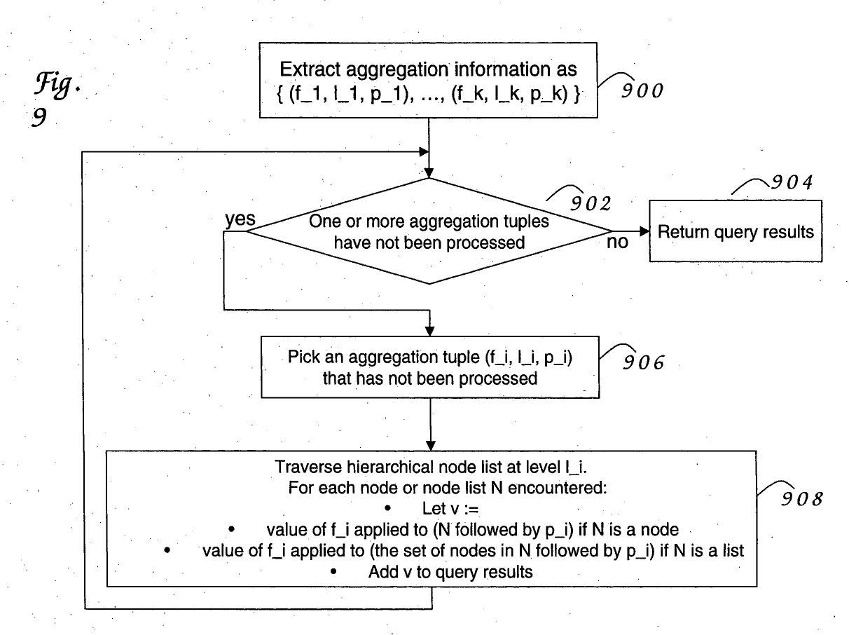

Once the grouping of the nodes is completed, and the hierarchical and regular node lists are merged (204), the nodes are processed in order to compute the aggregation values for each node list. Referring to FIG. 9, one embodiment of a method for processing the node lists is illustrated. At first, the aggregation information is extracted (900). The only relevant parts for the processing is the set of aggregation functions fᵢ to apply together with the level of the node list hierarchy lᵢ at which to apply them and a relative path expression pᵢ to be applied to each node before applying fᵢ. Once this information is obtained, it is checked whether more aggregation functions need to be applied or whether all aggregations were completed (902). If all were completed, the query result is returned (904). If at least one aggregation function still needs to be applied, one is picked (906) and the aggregation value is computed (908). This last step encompasses selecting all nodes or node lists from the hierarchical node list at level lᵢ and then applying fᵢ to a single node or a node list, depending on whether level lᵢ stores nodes or lists. As an example, the function AVG could be applied to a single node simply returning its value. However, when applied to a node list, it would return the average of all node values in that node list. It is to be appreciated that fᵢ is not simply applied directly to the nodes found in the hierarchical node list but rather to the nodes determined by following path pᵢ from the nodes found in the hierarchical node list. This additional path “redirection” allows to support more complex user queries. Once the aggregation value is computed for each node or node list encountered at level lᵢ, the values are added to the query result and it is again checked whether more aggregation functions need to be applied (902).

It is to be understood that the present invention, in accordance with at least one presently preferred embodiment, includes an arrangement for reading scoped dimension information for an input XML document, an arrangement for accessing tree information of an input XML document, an arrangement for parsing a user query, an arrangement for executing the user query, and an arrangement for returning a query result as a hierarchical structure. Together, these elements may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

### REFERENCES

1. K. Beyer, R. Cochrane, L. Colby, F. Ozcan, H. Pirahesh, XQuery for Analytics: Challenges and Requirements, XIME-P:2004, pages 3-8, 2004.

2. S. Chaudhuri and U. Dayal, An Overview of Data Warehousing and OLAP Technology. Data Mining and Knowledge Discovery, 26(1):65-74, 1997.

3. World Wide Web Consortium. W3C Architecture Domain: XML. www.w3c.org/xml Online Documents.

4. J. Gray, S. Chaudhuri, A. Bosworth, A. Layman, D. Reichart, M. Venkatrao, F. Pellow, and H. Pirahesh, Data Cube: A Relational Aggregation Operator Generalizing Group-By, Cross-Tab and Sub-Totals, Data Mining and Knowledge Discovery, 1(1):29-53, March 1997.

5. S. Paparizos, S. Al-Khalifa, H. V. Jagdish, L. V. S. Lakshmanan, A. Nierman, D. Srivastava, and Y. Wu, Grouping in XML, In EDBT Workshop 2002, pages 128-147, 2002.

6. P. Vassiliadis and T. Sellis, A Survey of Logical Models for OLAP Databases, ACM SIGMOD Record, 28(4):49-64, 1999.

What is claimed is

1. A system for performing structured aggregation of XML documents, the system comprising:
an arrangement for reading scoped dimension information for an input XML document;
an arrangement for accessing tree information of an input XML document;
an arrangement for parsing a user query;
an arrangement for executing the user query; and
an arrangement for returning a query result as a hierarchical structure.

2. The system according to claim 1, wherein said parsing arrangement comprises:
an arrangement for representing structured aggregation operators from the user query; and
an arrangement for combining the structured aggregation operators and other standard XML query operators into a query tree.

3. The system according to claim 2, wherein said arrangement for representing structured aggregation operators comprises an arrangement for determining aggregation order from the user query.

4. The system according to claim 1, wherein said arrangement for executing the query comprises:
an arrangement for generating a hierarchy of node lists; and
an arrangement for processing the hierarchy of node lists while generating a query result.

5. The system according to claim 4, wherein said arrangement for generating a hierarchy of node lists comprises:
an arrangement for using the aggregation order to determine the structure of the hierarchy of node lists; and
an arrangement for populating the hierarchy of node lists based on at least one of: document node values and structural node properties.

6. The system according to claim 1, wherein said arrangement for returning a query result comprises an arrangement for using the aggregation order and the scoped dimension information to determine a structure of the query result.

7. A method of performing structured aggregation of XML documents, said method comprising the steps of:
reading scoped dimension information for an input XML document;
accessing tree information of an input XML document;
parsing a user query;
executing the user query; and
returning a query result as a hierarchical structure.

8. The method according to claim 7, wherein said parsing step comprises:
representing structured aggregation operators from the user query; and
combining the structured aggregation operators and other standard XML query operators into a query tree.

9. The method according to claim 8, wherein said step of representing structured aggregation operators comprises determining aggregation order from the user query.

10. The method according to claim 7, wherein said step of executing the query comprises:
generating a hierarchy of node lists; and
processing the hierarchy of node lists while generating a query result.

11. The method according to claim 10, wherein said step of generating a hierarchy of node lists comprises:
using the aggregation order to determine the structure of the hierarchy of node lists; and
populating the hierarchy of node lists based on at least one of: document node values and structural node properties.

12. The method according to claim 11, wherein said step of determining the structure of the node list hierarchy comprises the steps of:
traversing the hierarchy of the aggregation order; and
for each hierarchical level, collating nodes with common value and/or structural properties as specified in the user query into a group each.

13. The method according to claim 11, wherein said step of determining the structure of the node list hierarchy comprises the steps of:
traversing the hierarchy of the aggregation order;
for each hierarchical level, collating nodes with the same dimensional relationship as specified in the current level into a group each.

14. The method according to claim 11, wherein said step of determining the structure of the node list hierarchy comprises the step of:
for all possible combinations of elements in the aggregation order hierarchy, collating nodes with common value and/or structural properties as specified in the user query into a group each.

15. The method according to claim 10, wherein said step of processing the hierarchy of node lists comprises the steps of:
traversing the hierarchy of node lists;
for each hierarchical level, for each group in that level, executing the aggregation function as specified in the user query; and
collating the resulting aggregation values according to the node list hierarchy.

16. The method according to claim 7, wherein said step of returning a query result comprises using the aggregation order and the scoped dimension information to determine a structure of the query result.

17. A program storage device readable by machine, tangibly embodying a program of instructions executed by the machine to perform method steps for performing structured aggregation of XML documents, said method comprising the steps of:
reading scoped dimension information for an input XML document;
accessing tree information of an input XML document;
parsing a user query;
executing the user query; and
returning a query result as a hierarchical structure.
